(19) United States
(12) Patent Application Publication
(10) Pub. No.: US 2024/0361423 A1
(43) Pub. Date: Oct. 31, 2024

(54) HYBRID METHOD FOR INDOOR POSITIONING IN WIRELESS NETWORK

(71) Applicant: Samsung Electronics Co., Ltd., Suwon-si (KR)

(72) Inventors: Rebal Jurdi, Allen, TX (US); Neha Dawar, McKinney, TX (US); Yuming Zhu, Plano, TX (US); Johnny Kyu-Hui Han, Seoul (KR)

(21) Appl. No.: 18/630,867

(22) Filed: Apr. 9, 2024

Related U.S. Application Data
(60) Provisional application No. 63/462,401, filed on Apr. 27, 2023.

(51) Int. Cl. G01S 5/02

(52) U.S. Cl. CPC G01S 5/0264

(57) ABSTRACT

A method for estimating a position of an object comprises: receiving a motion event signal indicating a motion type of the object, the motion type being determined based on sensing data provided by one or more sensors; receiving one or more ranging measurements for distances between the object and one or more anchor points from a ranging device; determining a mode among a plurality of positioning modes based on the motion event and the one or more ranging measurements; and estimating a position of the object using the determined mode.

### CROSS-REFERENCE TO RELATED APPLICATIONS

This application claims the benefit of priority from U.S. Provisional Application No. 63/462,401, entitled “HYBRID METHODS FOR WIFI-RTT-BASED INOOR POSITIONING,” filed Apr. 27, 2023, which is incorporated herein by reference in its entirety.

### TECHNICAL FIELD

This disclosure relates generally to wireless communication systems, and more particularly to, for example, but not limited to, indoor positioning in wireless communication systems.

### BACKGROUND

Over the past decade, indoor positioning has surged in popularity, driven by the increasing number of personal wireless devices and the expansion of wireless infrastructure. Various indoor positioning applications have emerged, spanning smart homes, buildings, surveillance, disaster management, industry, and healthcare, all demanding broad availability and precise accuracy. However, traditional positioning methods often suffer from limitations such as inaccuracy, impracticality, and scarcity. Ultra-wideband (UWB) technology has been adopted for indoor positioning. While UWB offers great accuracy, it lacks widespread adoption of UWB devices for use as ranging anchor points, unlike Wi-Fi, which is ubiquitous in commercial and residential environments. With Wi-Fi access points and stations pervading most spaces, indoor positioning using Wi-Fi has emerged as a preferred solution.

The description set forth in the background section should not be assumed to be prior art merely because it is set forth in the background section. The background section may describe aspects or embodiments of the present disclosure.

### SUMMARY

An aspect of the present disclosure provides a method for estimating a position of an object. The method comprises: receiving a motion event signal indicating a motion type of the object, the motion type being determined based on sensing data provided by one or more sensors; receiving one or more ranging measurements for distances between the object and one or more anchor points from a ranging device; determining a mode among a plurality of positioning modes based on the motion event and the one or more ranging measurements; and estimating a position of the object using the determined mode.

In some embodiments, the sensing data are associated with at least one of acceleration, orientation, rotational velocity, step size or step heading.

In some embodiments, the plurality of positioning modes includes a first positioning mode and a second positioning mode. The first positioning mode estimates a position of the object based on a combination of the ranging measurements for the distances and the sensor data associated with step size and step heading. The second positioning mode estimates a position of the object based on round trip time (RTT) based distance measurement.

In some embodiments, the determining the mode comprises switching from the second positioning mode to the first positioning mode when a motion event signal indicating that the object moves in a straight line is received.

In some embodiments, the determining the mode comprises switching from the first positioning mode to the second positioning mode when a motion event signal indicating stop, fluctuation, or change in a heading of the object is received.

In some embodiments, the determining the mode comprises switching from the first positioning mode to the second positioning mode when a difference between a position estimate based on the first positioning mode and a position estimate based on the second positioning mode is larger than a threshold.

In some embodiments, the plurality of positioning modes further includes a third positioning mode that estimates a position of the object using a trilateration algorithm.

In some embodiments, the determining the mode comprises switching from the first positioning mode or the second positioning mode to the third positioning mode when a number of ranging measurements for the distances is smaller than a predetermined number.

In some embodiments, the plurality of positioning modes further includes a fourth positioning mode that estimates a position of the object using a positioning algorithm based on step size and step heading.

In some embodiments, the determining the mode comprises switching from the first positioning mode or the second positioning mode to the fourth positioning mode when a number of ranging measurements for the distances is smaller than a predetermined number.

Another aspect of the present disclosure provides a device for estimating a position of the device. The device comprises one or more sensors configured to provide sensing data, and a processor coupled to the one or more sensors. The processor configured to cause: receiving a motion event signal indicating a motion type of the device, the motion type being determined based on sensing data provided by the one or more sensors; measuring distances between the device and one or more anchor points; determining a mode among a plurality of positioning modes based on the motion event signal and one or more measurements of the distances; and estimating a position of the device using the determined mode.

In some embodiments, the sensing data are associated with at least one of acceleration, orientation, rotational velocity, step size or step heading.

In some embodiments, the plurality of positioning modes includes a first positioning mode and a second positioning mode. The first positioning mode estimates a position of the device based on a combination of the one or more measurements for the distances and the sensor data associated with step size and step heading. The second positioning mode estimates a position of the device based on round trip time (RTT) based distance measurement.

In some embodiments, the determining the mode comprises switching from the second positioning mode to the first positioning mode when a motion event signal indicating that the device moves in a straight line is received.

In some embodiments, the determining the mode comprises switching from the first positioning mode to the second positioning mode when a motion event signal indicating stop, fluctuation, or change in a heading of the object is received.

In some embodiments, the determining the mode comprises switching from the first positioning mode to the second positioning mode when a difference between a position estimate based on the first positioning mode and a position estimate based on the second positioning mode is larger than a threshold.

In some embodiments, the plurality of positioning modes further includes a third positioning mode that estimates a position of the device using a trilateration algorithm.

In some embodiments, the determining the mode comprises switching from the first positioning mode or the second positioning mode to the third positioning mode when a number of measurements for the distances is smaller than a predetermined number.

In some embodiments, the plurality of positioning modes further includes a fourth positioning mode that estimates a position of the device using a positioning algorithm based on step size and step heading.

In some embodiments, the determining the mode comprises switching from the first positioning mode or the second positioning mode to the fourth positioning mode when a number of ranging measurements for the distances is smaller than a predetermined number.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3A shows an example of a range-based positioning process in accordance with an embodiment.

FIG. 3B shows an example of a range-and-sensor-based positioning process in accordance with an embodiment.

FIG. 4 shows an example of Fine Timing Measurement (FTM) parameters element format in accordance with an embodiment.

FIG. 5 shows an example measurement phase of an FTM session in accordance with an embodiment.

FIG. 6A shows an example step and heading (SH) motion model in accordance with an embodiment.

FIG. 6B shows an example random walk (RW) motion model in accordance with an embodiment.

FIG. 7 shows an example positioning solution in accordance with an embodiment.

FIGS. 8A to 8C shows examples of motion events in accordance with an embodiment.

FIG. 9 shows an example process for generating an event bitmap in accordance with an embodiment.

FIG. 10A illustrates a timing diagram depicting the detection of a continuous motion (CM) event in accordance with an embodiment.

FIG. 10B illustrates a timing diagram depicting the detection of a halt (H) event in accordance with an embodiment.

FIG. 10C illustrates an example flowchart depicting a process performed by a motion signal dispatcher (MSD) to detect a continuous motion (CM) event or a halt (H) event in accordance with an embodiment.

FIG. 11 shows an example comparing unwrapped angles and wrapped angles in accordance with an embodiment.

FIGS. 12A to 12C show another example process to detect motion events in accordance with an embodiment.

FIGS. 13A to 13C show another example process to detect motion events in accordance with an embodiment.

FIG. 14 shows an example model depicting switching positioning modes in accordance with an embodiment.

FIG. 15 shows a state diagram for one implementation of a position state machine in accordance with an embodiment.

FIG. 16 shows a state diagram for one implementation of a position state machine in accordance with an embodiment.

FIG. 17 shows a state diagram for one implementation of a position state machine in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

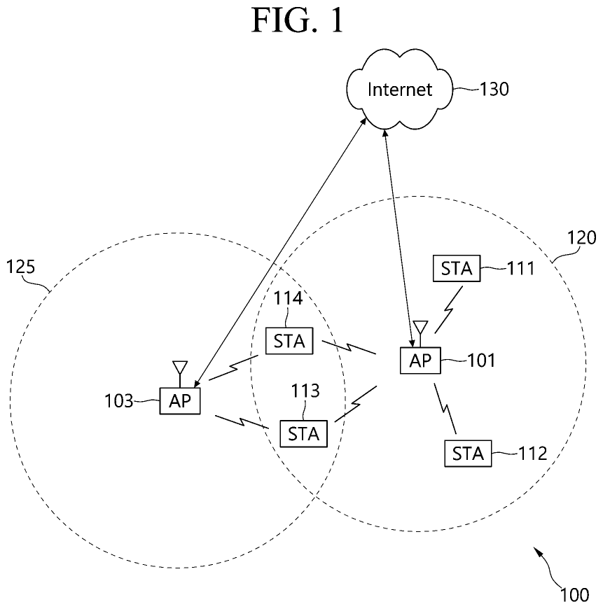

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

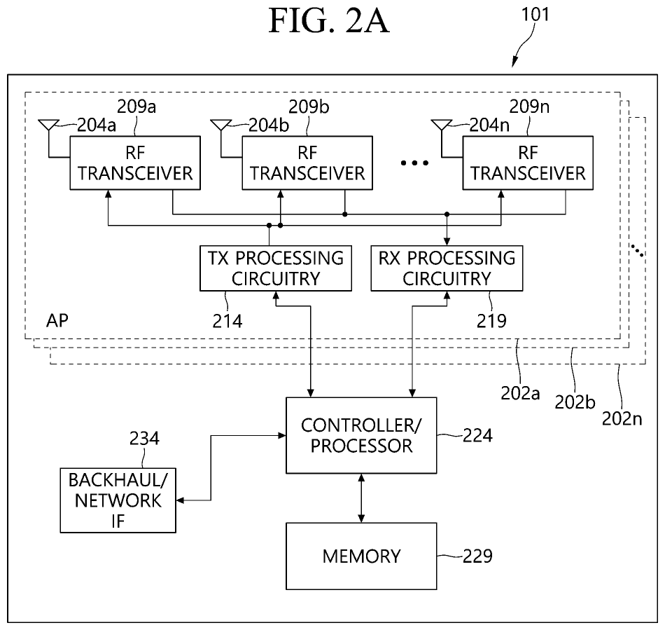

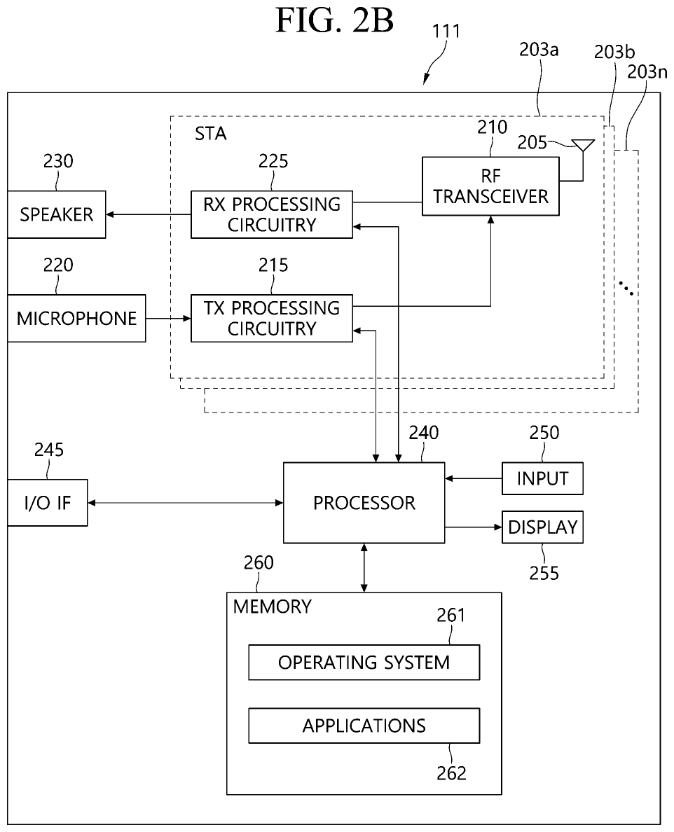

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

Device-based positioning refers to the challenge of determining a user's location using the device that the user is carrying. Solutions to this challenge can generally be categorized into three main groups.

The first category is wireless or range-based methods. Positioning is estimated through range measurements, such as measuring distances from anchor points or reference points with known position coordinates. Examples of range measurements include received signal strength indicator (RSSI), time of flight (ToF), and round-trip time (RTT).

The second category is pedestrian dead reckoning (PDR) or sensor-based methods. Positioning is estimated through accumulating incremental displacements on top of a known initial position. The displacement may be computed from sensor readings, such as magnetometer, accelerometer, and gyroscope.

The third category is sensor fusion or range-and-sensor-based methods. Positioning is first estimated from sensor readings through PDR and then updated through fusion with range measurements.

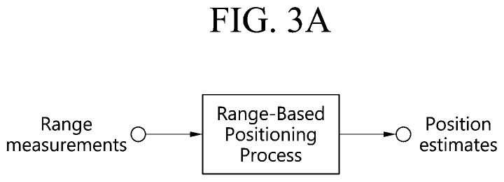

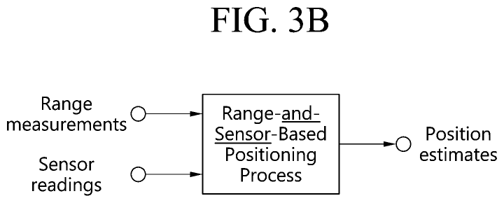

FIG. 3A shows an example of a range-based positioning process and FIG. 3B shows an example of a range-and-sensor-based positioning process in accordance with an embodiment. As shown in FIGS. 3A and 3B, position estimates are based on range measurements in the range-based positioning process, while position estimates are based on both range measurements and sensor readings in the range-and-sensor-based positioning process.

As explained, indoor positioning has grown in popularity over the last decade. UWB may offer a solution due to its high accuracy. However, UWB devices suitable for the use as ranging anchor points are rare and uncommon compared to Wi-Fi devices, which are ubiquitous in both commercial and residential spaces. Therefore, given the pervasiveness of Wi-Fi access points and stations, Wi-Fi based round-trip time (RTT) has emerged as the strongest contender in the indoor positioning race. Furthermore, the Wi-Fi standard, or IEEE 802.11 standard, provides the Fine Timing Measurement (FTM) mechanism for accurate ranging.

### Fine Timing Measurement (FTM)

The FTM is a wireless network management procedure defined in IEEE 802.11-2016, which was merged into IEEE 802.11-2020, enabling a station (STA) to accurately measure its distance from other STAs or access points by measuring the RTT between two devices. For instance, when a STA seeks to localize itself (referred to as the initiating STA) with respect to other STA (referred to as the responding STA), the STA schedules an FTM session during which the STAs exchanges messages and measurements. The FTM session typically comprises three phases: negotiation, measurement exchange, and termination.

In the negotiation phase, the initiating STA may negotiate key parameters with the responding STA, such as frame format, bandwidth, number of bursts, burst duration, burst period, and number of measurements per burst. The negotiation may start when the initiating STA sends an FTM request frame, which is a management frame with subtype Action, to the responding STA. The FTM request frame may be called the initial FTM request frame. This initial FTM request frame may include the negotiated parameters and their values in the frame's FTM parameters element. The responding STA may respond with an FTM frame called initial FTM frame, which approves or overwrites the parameter values proposed by the initiating STA.

In the measurement phase, one or more bursts may be involved. Each burst includes one or more fine time measurements. The duration of a burst and the number of measurements may be defined by parameters, such as burst duration and FTMs per burst. The bursts are separated by interval defined by the parameter, such as burst duration.

In the termination phase, an FTM session terminates after the last burst instance, as indicated by parameters in the FTM parameters element.

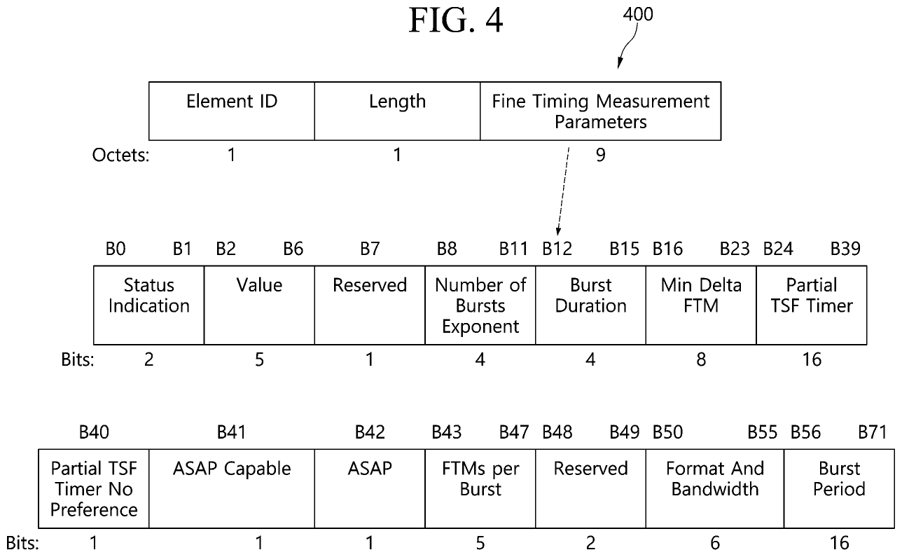

FIG. 4 shows an example of FTM parameters element format in accordance with an embodiment. The FTM parameters element may be usable in IEEE 802.11 standard.

The FTM parameters element 400 may include a number of fields that are used to advertise the requested or allocated FTM configuration from one STA to another STA. The FTM parameters element may be included in the initial FTM request frame and the initial FTM frame.

The FTM parameters element 400 may include an Element ID field, a Length field, and a Fine Timing Measurement Parameters field. The Element ID field includes an information to identify the FTM parameters element 400. The Length field indicates the length of the FTM parameters element 400. The Fine Time Measurement Parameters field includes a Status indication field, a Value field, a Reserved field, a Numbers of Bursts Exponent field, a Burst Duration field, a Min Delta FTM field, a Partial TST Timer field, a Partial TST Timer No Preference field, an ASAP Capable field, an ASAP field, a FTMs Per Burst field, a Reserved field, a Format And Bandwidth field, and Burst Period field.

The Status Indication field and Value field are reserved in the initial FTM request frame. The number of Burst Exponent field indicates how many burst instances are requested for the FTM session. The Burst Duration field indicates the duration of a burst instance. The Min Delta FTM field indicates the minimum time between consecutive FTM frames. The value in the Partial TSF timer field is the partial value of the responding STA's TSF at the start of the first burst instance. The Partial TSF Timer No Preference field indicates a preferred time for the start of the first burst instance in the initiating STA. The ASAP Capable field indicates that the responding STA is capable of capturing timestamps associated with an initial FTM frame and its acknowledgment and sending them in the following FTM frame. The ASAP field indicates the initiating STA's request to start the first burst instance of the FTM session with the initial FTM frame and capture timestamps corresponding to the transmission of the initial FTM frame and the receipt of its acknowledgment. The FTMS Per Burst field indicates how many successfully transmitted FTM are requested per burst instance by the initial FTM request frame or allocated by the initial FTM frame. The Format And Bandwidth field indicates the requested or allocated PPDU (physical layer protocol data unit) format and bandwidth that can be used by FTM frames in an FTM session. The Burst Period field indicates the interval between two consecutive burst instances.

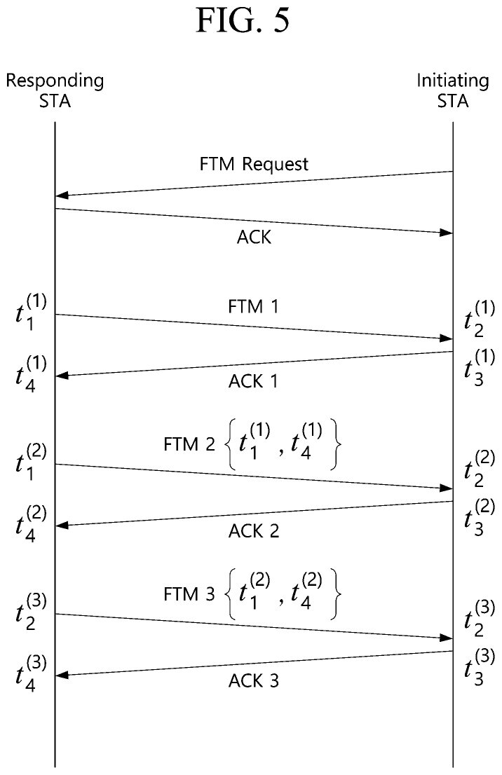

FIG. 5 shows an example measurement phase of an FTM session in accordance with an embodiment. In the example of FIG. 5, the FTM session includes one burst and three FTMs per burst.

Referring to FIG. 5, the measurement phase of the FTM session comprises following operations:
The initiating STA sends an initial FTM request frame to the responding STA. The FTM request frame triggers the start of the FTM session.
In response, the responding STA responds with an ACK.
Subsequently, the responding STA sends the first FTM frame to the initiating STA and captures the transmit time as t₁⁽¹⁾.
Upon receiving the first FTM frame (FTM 1), the initiating STA captures the receive time as t₂⁽¹⁾.
The initiating STA responds with an acknowledgement (ACK 1) and captures the transmit time as t₃⁽¹⁾.
Upon receiving the ACK, the responding STA captures the receive time as t₄⁽¹⁾.
The responding STA sends a second FTM frame (FTM 2) to the initiating STA and captures the transmit time as t₁⁽²⁾. This frame serves two purposes. Firstly, the second FTM frame (FTM 2) is a follow-up to the first FTM frame (FTM 1), transmitting the timestamps t₁⁽¹⁾ and t₄⁽¹⁾ recorded by the responding STA. Secondly, the second FTM frame starts a second measurement.
Upon receiving the second FTM frame, the initiating STA extracts the timestamps t₁⁽¹⁾ and t₄⁽¹⁾ and computes the RTT using the following equation:

$$RTT = ( {t}_{4}^{( 1 )} - {t}_{1}^{( 1 )} ) - ( {t}_{3}^{( 1 )} - {t}_{2}^{( 1 )} )$$

and captures the receive time as t₂⁽²⁾.
The initiating STA and the responding STA continue exchanging FTM frames and ACKs for as many measurements as there have been negotiated between the two.

For use in positioning and proximity applications, the RTT between the two STAs may be converted into a distance using the following equation:

$$d = \frac{RTT}{2} c$$

where d refers to the distance between the two STAs and c refers to the speed of light.

Each FTM of the burst may yield a distance sample. Therefore, multiple distance samples are obtained per burst. Given multiple FTM burst and multiple measurements per burst, these distance samples can be combined in various ways to produce a representative distance measurement. For instance, the mean distance, the median distance, or some other percentile of distance can be calculated. Furthermore, other statistics such as the standard deviation can also be utilized for positioning applications.

In an RTT-based indoor positioning system, the Wi-Fi enabled device ranges with a set of anchor points (APs) with pre-defined locations to estimate its position. The device constantly makes ranging requests to the APs and waits for ranging responses. The device can infer the distances to each of them from the responses. Finally, the device converts the set of distances into a position estimate using techniques such as trilateration, which is a common algorithm that minimizes the sums of square errors in distance between the device and each AP. Additionally, more sophisticated algorithms within the Bayesian framework can be employed.

### Pedestrian Dead Reckoning (PDR)

Dead Reckoning is a method of estimating the position of a moving object by adding incremental displacements to its last known position. Pedestrian dead reckoning (PDR) specifically refers to scenarios where the moving object is a pedestrian walking indoors or outdoors. With the proliferation of sensors embedded in smart devices, such as smartphones, tablets, and smartwatches, the PDR has naturally evolved to complement wireless positioning technologies, which have long relied on devices providing Wi-Fi or cellular services, as well as more recent and less common technologies like UWB. An inertial measurements unit (IMU) may refer to a device that comprises various sensors with distinct functions, including the accelerometer for measuring linear acceleration, the gyroscope for measuring angular velocity, and the magnetometer for measuring the strength and direction of the magnetic field. These sensors can detect motion and enable estimation of velocity (i.e., speed and heading), thereby enhancing positioning accuracy. Methods utilizing the PDR can generally be categorized into two groups: inertial navigation (IN) method and step-and-heading (SH) method.

The IN method tracks the position and orientation (i.e., direction), also known as attitude or bearing, of the device in two- or three-dimensional (3D) space. To determine the instantaneous position, the IN method integrates the 3D acceleration to obtain velocity, and then integrates velocity to determine the displacement from the starting point. Similarly, in order to obtain the instantaneous orientation, the IN method integrates the angular velocity from the gyroscope to obtain changes in angles from the initial orientation. However, measurement noise and biases at the level of the accelerometer and gyroscope cause a linear growth of orientation offset over time due to rotational velocity integration, and quadratic growth of displacement error over time due to double integration of the acceleration. This often forces the IN system into a tradeoff between positioning accuracy and computational complexity. Tracking and mitigating biases in sensor reading as well as managing the statistics of measurement noise over time often require complex filters with high-dimensional state vectors.

Unlike the IN method, which continuously tracks the position of the device, the SH method updates the device position less frequently by accumulating steps taken by the user from the starting point. Every step can be represented as a vector, with a magnitude indicating the step size and an argument indicating the heading of the step. Instead of directly integrating sensor readings to compute displacement and changes in orientation, the SH method performs a series of operations toward that end. First, the SH system detects a step or a stride using various methods, such as peak detection, zero-crossing detection, or template matching. Second, upon detecting a step or stride, the SH system estimates the size of the step based on the sequence of acceleration over the duration of the step. Third, the SH system estimates the heading of the step using the gyroscope, magnetometer, or a combination of both. All the three steps are prone to errors. Step detection may suffer from misdetection, for example, due to low peaks or false alarm caused by double peaks, among other drawbacks. Similarly, errors in underlying sensor measurements and idealized models can lead to inaccuracies in step size and heading estimation. Like the IN method, the SH method also involves a trade-off between computation complexity and positioning accuracy. However, unlike the IN method, the SH method is less susceptible to drifting, particularly when estimated trajectories are corrected with range measurements in what has been previously defined as sensor-fusion-based indoor positioning system.

### Bayesian Filter

The Bayesian framework is a mathematical tool used to estimate the state of an observed dynamic system or its probability. In this framework, the trajectory of the system is represented by a motion model, also known as a state transition model, which describes how the system evolves over time. The measurement of a state is expressed through a measurement model or an observation model, which relates the state or its probability at a given time to measurements collected at that time. With an incoming stream of measurements, the state of the system is recursively estimated in two stages, measurement by measurement. In the first stage, known as the prediction stage, the state at a point in the near future is predicted solely using the motion model. In the second stage, known as the update stage, measurements are used to correct the prediction state. The successive application of the prediction stage and update stage gives rise to what is known as the Bayesian filter. Mathematical details are provided below.

The motion model describes the evolution of the state of the system and relates the current state to the previous state. There are two ways to express the relationship: direct relationship and indirect relationship.

In the direct relationship, the new (next) state xx can be expressed as a random function of the previous state xₖ₋₁ and input to the system uₖ:

$${x}_{k} = f ( {u}_{k} , {x}_{k - 1} ) .$$

Indirect relationship: a transition kernel can be provided as:

$$p ( {x}_{k} \vert {x}_{k - 1} , {u}_{k} ) .$$

Measurement Model relates the current observation to the current state. Similarly, there are two ways to express this relationship: direct relationship and indirect relationship.

In the direct relationship, the observation yₖ can be expressed as a random function of the current state xₖ:

yₖ=g(xₖ)

In the indirect relationship, the likelihood distribution can be provided as:

p(yₖ|xₖ)

Initially, the Bayesian filter starts with a belief b₀(x₀)=p(x₀) about the state of the system at the very beginning. At each time index k, the Bayesian filter refines the belief of state of system by applying the prediction stage followed by the update stage. The state of the system can then be estimated from the belief, as the minimum mean square error estimate (MMSE), the maximum a posteriori estimate (MAP), or other methods.

In the Prediction stage, the Bayesian filter determines ‘a priori’ belief bₓ⁻(sₖ) using the state transition model as follows:

$${b}_{k}^{-} ( {s}_{k} ) = \int \int {b}_{k - 1} ( s ) p ( s \vert {s}_{k - 1} , {u}_{k} ) ds$$

In the updated stage, the Bayesian filter updates ‘a posteriori’ belief bₖ(sₖ) using the measurement model as follows:

$${b}_{k} ( {s}_{k} ) = {b}_{k}^{-} ( {s}_{k} ) \cdot p ( {y}_{k} \vert {s}_{k} )$$

Once the ‘a posteriori’ belief has been determined, the state can be estimated in various way including the below example:

$${\hat{s}}_{k}^{MAP} = {arg max}_{s} {b}_{k} ( s )$$

$${\hat{s}}_{k}^{MMSE} = \int \int {b}_{k} ( s ) ds$$

### Kalman Filter

When both of the motion model and the measurement model are linear, the Bayesian filter reduces to the well-known Kalman filter. The motion and measurement equations for a linear system, and the prediction stage and the update stage for the corresponding Kalman filter are described below.

The motion equation describes the evolution of the state of the system and relates the current state to the previous state as follows:

$${x}_{k} = {A}_{k} {x}_{k - 1} + {B}_{k} {u}_{k} + {v}_{k}$$

where xₖ is the current state, xₖ₋₁ is the last state, Aₖ is the state transition matrix, uₖ is the current input, Bₖ is the control/input matrix, and vₖ˜N(0,Qₖ) is the process noise which represents uncertainty in state.

The measurement equation relates the current observation to the current state as follows:

$${y}_{k} = {H}_{k} {x}_{k} + {w}_{k}$$

where yₖ is the latest observation, Hₖ is the observation matrix, and wₖ˜N(0, Qₖ) is the observation noise.

At each time index k, the Kalman filter estimates the state of the system by applying a prediction stage followed by an update stage. The outcome of these two steps is the state estimate \hat{x}ₖ at time index k and the covariance matrix Pₖ which are in turn used to estimate the states at later points in time.

In the prediction stage, the Kalman filter predicts the current state \hat{x}_{k|k-1} (a priori estimate) from the most recent state estimate \hat{x}ₖ₋₁, the covariance Pₖ₋₁, and any inputs using the motion equation as follows:

$${\hat{x}}_{k \vert k - 1} = {A}_{k} {\hat{x}}_{k - 1} + {B}_{k} {u}_{k} ,$$

$${P}_{k \vert k - 1} = {A}_{k} {P}_{k} {A}_{k}^{*} + {Q}_{k} ,$$

In the update stage, the Kalman filter uses the latest observation to update the prediction and obtain the ‘a posteriori’ state estimate \hat{x}ₓ and its covariance Pₖ as follows:

$${\hat{x}}_{k} = {\hat{x}}_{k \vert k - 1} + {K}_{k} ( {y}_{k} - {H}_{k} {\hat{x}}_{k \vert k - 1} )$$

$${P}_{k} = ( I - {K}_{k} {H}_{k} ) {P}_{k \vert k - 1}$$

where Kₖ is the Kalman gain and is a function of the ‘a priori’ estimate covariance P_{k|k-1}, observation matrix Hₖ, and observation noise covariance matrix Rₖ.

The extended Kalman filter (EKF) is a work-around to handle non-linearities in the motion model or measurement model. If the motion equation or the measurement equation is not linear, the Kalman filter may not be used unless these equations are linearized. Consider the following non-linear motion equation and measurement equation:

$${x}_{k} = {f}_{k} ( {x}_{k - 1} , {u}_{k} ) + {v}_{k}$$

$${y}_{k} = {h}_{k} ( {x}_{k} ) + {w}_{k}$$

where fₖ and hₖ are non-linear functions. The EKF applies the predict stage and update stage as follows:

In the prediction stage,

$${\hat{x}}_{k \vert k - 1} = {f}_{k} ( {\hat{x}}_{k - 1} , {u}_{k} )$$

$${P}_{k \vert k - 1} = {F}_{k} {P}_{k} {F}_{k}^{*} + {Q}_{k}$$

$$where$$

$${F}_{k} = \frac{\partial {f}_{k} ( x , u )}{\partial x} {\vert}_{x = {\hat{x}}_{k - 1} , u = {u}_{k}}$$

In the update stage,

$${\hat{x}}_{k} = {\hat{x}}_{k \vert k - 1} + {K}_{k} ( {y}_{k} - {H}_{k} {\hat{x}}_{k \vert k - 1} )$$

$${P}_{k} = ( I - {K}_{k} {H}_{k} ) {P}_{k \vert k - 1}$$

$$where$$

$${F}_{k} = \frac{\partial {h}_{k} ( x )}{\partial x} {\vert}_{x = {\hat{x}}_{k - 1}}$$

The state estimate \hat{x}ₖ and the covariance Pₖ are propagated to track the state of system. In the context of positioning, the state refers to the device position. In the context of Wi-Fi RTT indoor positioning, the observation refers to the RTT distance measurement.

### Motion Models

In Wi-Fi RTT based positioning, the measurement model is typically taken to be an additive white Gaussian noise model:

$${y}_{k} = d ( {x}_{k} ) + {z}_{k}$$

where the measurement RTT distance yₖ is expressed as the true distance d(xₖ) between the device and the AP, plus a measurement noise term zₖ that is uncorrelated over time.

However, the motion model may be determined by the type of positioning solution as explained above. It is tailored according to the sensors available on the target device or their absence. In a range-based positioning method where IMU sensors are inaccessible, unavailable, or completely dismissed, the position of the target device can only be determined by measuring the distance to anchor points at known locations. This leads to free-range or random walk (RW) motion model that allows the target device to move freely in the vicinity of its last known position. In a sensor-based or sensor-fusion positioning method, the position of the device can be predicted through IMU sensors in the device. In a step and heading (SH) method, for instance, the position of the device is predicted by adding a displacement vector to its last known position. The displacement vector can be a sum of steps, composed of a size (magnitude) and heading (argument or angle), is computed from IMU sensors, such as accelerometer for step size, and magnetometer and gyroscope for step heading.

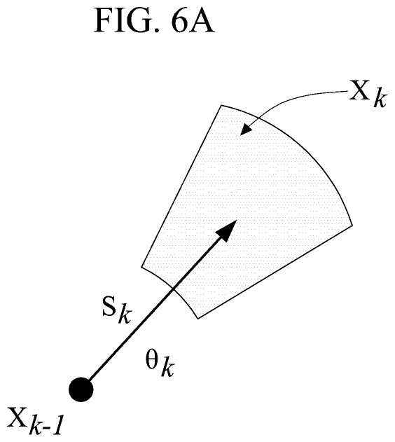

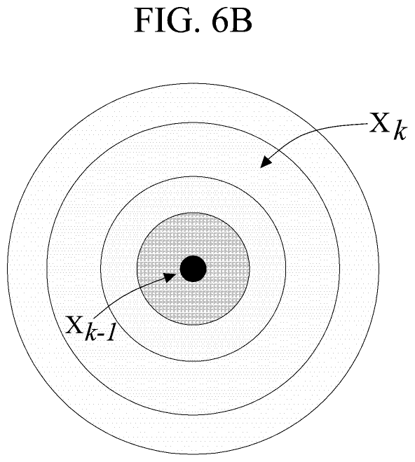

FIG. 6A shows an example step and heading (SH) motion model in accordance with an embodiment. As shown in FIG. 6A, the device position xx is a function of its last known position xₖ₋₁ and a displacement vector composed of the size (magnitude) xₖ and heading (angle or argument) θₖ.

FIG. 6B shows an example random walk (RW) motion model in accordance with an embodiment. As shown in FIG. 6B, the device position xx is in the vicinity of its last known position xₖ₋₁.

While PDR motion models offer pinpointing the next position from the current one, they are susceptible to errors induced by sensor noise and biases which may mislead the positioning algorithm into making false predictions. Furthermore, the presence of unpredicted noise levels and unknown biases may render free-range motion models (e.g., random walk model) preferred.

Free-range motion models leave the task of position estimation entirely up to the measurement model. However, ranging errors can render RTT ranging measurements unreliable, making PDR motion models the preferred choice.

Consequently, both the PDR motion model and the free-range model have their drawbacks. The PDR model is susceptible to unpredictable sensor noise and unknown sensor bias, while the free-range model is susceptible to ranging errors.

In this disclosure, a positioning state machine (PSM) is provided. The positioning state machine may decide whether a free-range model or a PDR motion is more appropriate based on a set of radio conditions and motion events.

Furthermore, a motion signal dispatcher (MSD) is provided. The MSD may detect key motion events and provide the PSM with necessary signals to facilitate mode switching.

The indoor positioning solution provided in this disclosure can be implemented in software, firmware, and/or hardware. In software, it can be implemented as an application (or app) deployed on a Wi-Fi enabled device such as phone or tablet with which the user can interact. Alternatively, the indoor positioning solution can be implemented as a background service accessible through an application programming interface (API), which provides device position data. Additionally, the indoor positioning solution can be implemented in the cloud on a server, where it communicates inputs (measurements) and outputs (position estimates) with the device over an internet connection, for example, Wi-Fi or cellular network.

The MSD and PSM may be first framed within the context of a positioning application. While the term ‘application’ commonly refers to a software program, or ‘app’ for short, a distinction may be made between these two terms in this disclosure. In some embodiments, the term ‘app’ may specifically refer to the software manifestation or implementation of the ‘application’, which can alternatively have hardware, firmware, or mixed implementations. The MSD and PSM may be examples among various components that ultimately serve a positioning application.

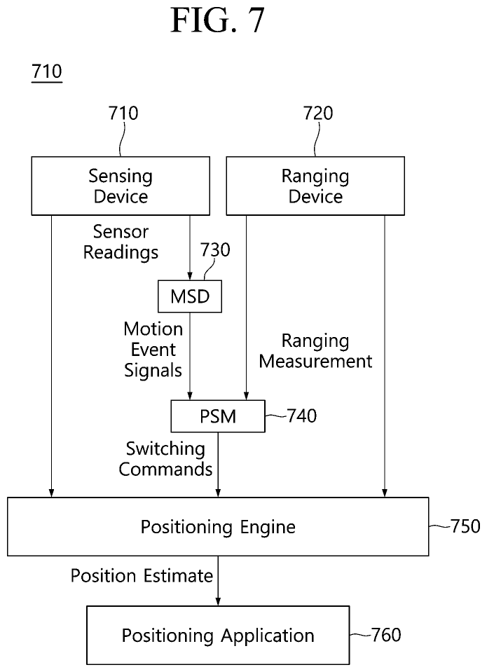

FIG. 7 shows an example positioning solution in accordance with an embodiment. The operation depicted in FIG. 7 is for illustration purposes and does not limit the scope of this disclosure to any particular implementations.

In FIG. 7, the positioning solution 700 comprises various components including a sensing device 710, a ranging device 720, a motion signal dispatcher (MSD) 730, a positioning state machine (PSM) 740, a positioning engine 750, and positioning application 750.

The sensing device 710 includes various sensors that measure the linear or rotational forces acting on the device, as well as its orientation. The sensors convert their measurements into useful physical quantities. For instance, an accelerometer computes acceleration, a gyroscope computes rotational velocity, and a magnetometer computes orientation. Additionally, the sensing device 710 may include various software sensors that generate contextual and activity-related information, such as step detection, from readings of hardware sensors like those mentioned above. The sensing device provides sensor data (e.g., sensor reading) to both MSD 730 and the positioning Engine 750.

The ranging device 720 measures the distance between the device and a set of anchor points. In some embodiments, the ranging device 720 may be a STA supporting Wi-Fi or IEEE 802.11 standard, acting as a FTM initiator (FTMI). Under this capacity, the STA interacts with an access point supporting Wi-Fi or IEEE 802.11 standard, acting as an FTM responder (FTMR) to compute the RTT between the two devices and convert it into distance. The ranging device 720 provides ranging measurement to both the PSM 740 and the positioning engine 750.

The MSD 730 detects motion events of interest based on the sensor data provided by the sensing device 710, including acceleration, orientation, step size, and heading. The MDS 730 signals detected motion events to the PSM 740.

The PSM 740 detects motion event signals from the MSD 730 and observes ranging measurements provided by the ranging device 720 to make decision on the positioning mode to be used by the positioning engine 750.

The positioning engine 750 estimates device position using a combination of ranging measurement, distance, and movement information. Then, the positioning engine 750 provides position estimates to the positioning application 760.

The positioning application 760 uses position estimates provided by the positioning engine 750 to carry out various tasks that may or may not involve user interaction, such as navigation, proximity detection, and asset tracking.

The positioning technique may require a user input to map the step heading obtained from the sensing device into the coordinate system used to express the position of the device and the anchor points. For example, it is often measured in degrees where 0, 90, 180, and 270 degrees correspond to North, East, South, and West, respectively. The y- and x-axes of the coordinate system may not necessarily align with the North and East.

In some embodiments, the MSD 730 detects motion events of interest that can be used as triggers for transitioning among a plurality of positioning modes. The MSD 730 receives streaming inputs from the sensing device 710, including acceleration, orientation, and step size, and heading, and converts them into streaming outputs that signal motion events of interest to the PSM 740.

In some embodiments, the motion events include a continuous motion (CM), a bounded motion (BM), a straight-line motion (STLM), a waver (W), a swerve(S), and a halt (H). The continuous motion (CM) indicates continuous movement, where the user or device takes one step after another with no gaps in between. The bounded motion (BM) indicates that the user or device maintains a heading that changes minimally. The straight-line motion (STLM) indicates that the user or device moves along a straight line. It can encompass both the CM and BM. The waver (W) indicates significant fluctuations in the heading of the user or device. The swerve(S) indicates rapid changes in the heading of the user or device, for example, due to making a sharp turn. The halt (H) indicates the user or device stops moving.

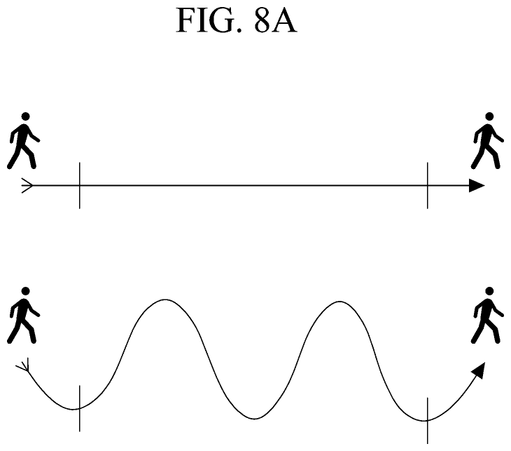

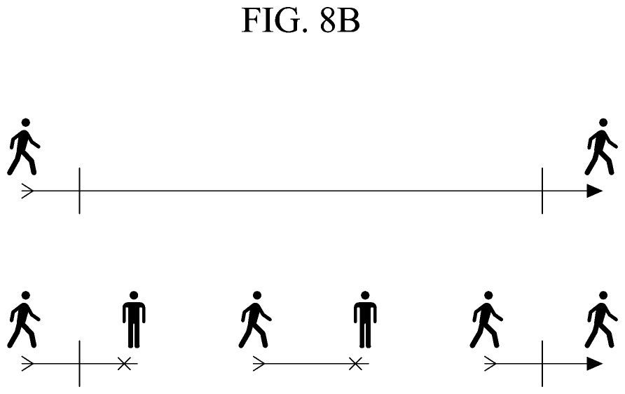

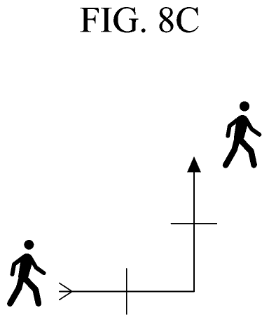

FIGS. 8A to 8C shows examples of motion events in accordance with an embodiment. In FIG. 8A, the top figure shows the continuous motion, bounded motion, and straight-line motion event, while the bottom figure shows the continuous motion and waver events. In FIG. 8B, the top figure shows the continuous motion, bounded motion, and straight-line motion event, while the bottom shows 2 halt events, but it is not clear where there is bounded or waver motion for the last event. FIG. 8C shows the swerve event.

The MSD 730 may define a sliding checking window of duration W. The MSD 730 detects and signals motion events in real time. In an embodiment, the MSD 730 detects and signals motion events with every new sensor sample, which corresponds to a signal dispatch rate f according to the following formula:

$$f = \frac{1}{\frac{1}{{f}_{a}} + \frac{1}{{f}_{ϕ}}}$$

where fₐ and f_{ϕ} are the rates of the acceleration sensors (e.g. accelerometer) and orientation sensors (e.g. magnetometer or gyroscope). The MSD 730 uses the stream of acceleration {at}, orientation {ϕₜ}, and step size and heading {sₗ, θₗ} (where l represents step) that it obtains from the sensing device 710 to determine what motion events have occurred. Upon a change in the value of the acceleration or orientation sensors, the MSD 730 processes the new sensor reading to determine whether any motion events have occurred.

In some embodiments, the MSD 730 may maintain event bitmap e corresponding to the motion events of interest, which include:
e^{CM} for continuous motion event;
e^{BM} for bounded motion event;
e^{STLM} for straight-line motion event;
e^{W} for waver event;
e^{S} for swerve event; and
e^{H} for halt event.

The MSD 730 updates the event bitmap et in real-time. In some embodiments, the MSD 730 updates on a sample-by-sample basis upon reading a new sample acceleration or orientation from sensors. This update process may involve observing samples from the past W seconds, denoted as the checking window [t−W, t]. The size of the checking window needs to consider the walking speed of the user and the specific use case. The choice of the window size also influences the choice of other event-related parameters, will be discussed below.

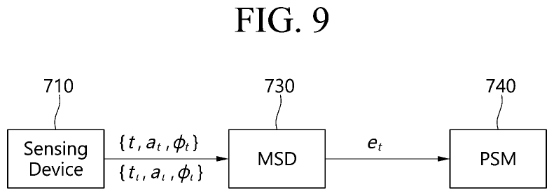

FIG. 9 shows an example process for generating an event bitmap in accordance with an embodiment. The operation depicted in FIG. 9 is for illustration purposes and does not limit the scope of this disclosure to any particular implementations.

In FIG. 9, the MSD 730 generates an event bitmap an event bitmap et from information based on the inputs from the sensing device 710. The inputs include the stream of acceleration {at}, orientation {Pt}, and step size and heading {sₗ, θₗ} at tₗ. Then, the MSD 730 signals the generated event bitmap et to the PSM 740.

### Continuous Motion and Halt

The MSD 730 detects a continuous motion (CM) event when the checking window ends in the most acceleration reading at and contains all acceleration values {a_{τ}} where t falls within the window t−W≤τ≤t. In an embodiment, the CM event may be detected when the checking window includes at least N₂ peaks in acceleration, or equivalently N₂ steps. For example, with W=6 s, N₂ ranges from 3 to 12, corresponding to a walking pace of 0.5 to 2 steps per second.

The MSD 730 may serve as a step detector for detecting steps. For example, if the MSD 730 is integrated into or part of a positioning application deployed on a mobile device, the MSD 730 may access a built-in step detector through the operating system API, which is common in newer operating systems. In such cases, the API provides the step detector as a software sensor, deriving its output from a combination of hardware sensors or other software sensors. Alternatively, if no step detector is readily available, the MSD 730 can implement a peak detector to detect a step when it detects a peak in acceleration.

When the MDS 730 detects a continuous motion (CM) event, it sets the corresponding bit e^{CM} and signals the CM event to the PSM 740. Otherwise, it clears e^{CM}.

The MSD 730 detects a halt (H) event when the checking window ends in the most recent acceleration reading including at most N₁≤N₂ peaks in acceleration or equivalently N₁ steps. For example, if W=5 and N₂=8, N₁ can be chosen in the range of 1 to 3. The parameters W, N₁, and N₂ can be tuned through a thorough search performed on data collected by different users with varying walking speeds and patterns. When the MSD 730 detects the halt (H) event, it sets the corresponding bit e^{H} and signals the halt (H) event to the PSM 740. Otherwise, it clears e^{H}.

The choice of the checking window size W is crucial. If the checking window size is too small, a halt (H) event may be frequently detected. Conversely, if the checking window size is too large, the continuous motion (CM) event may be frequently detected.

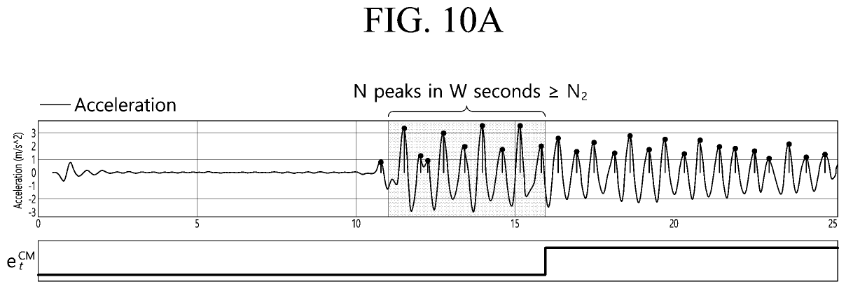

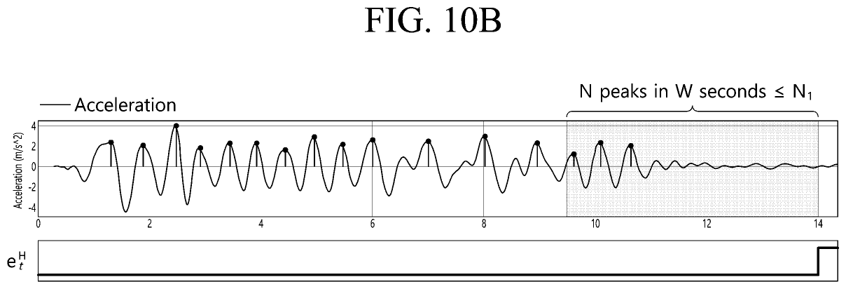

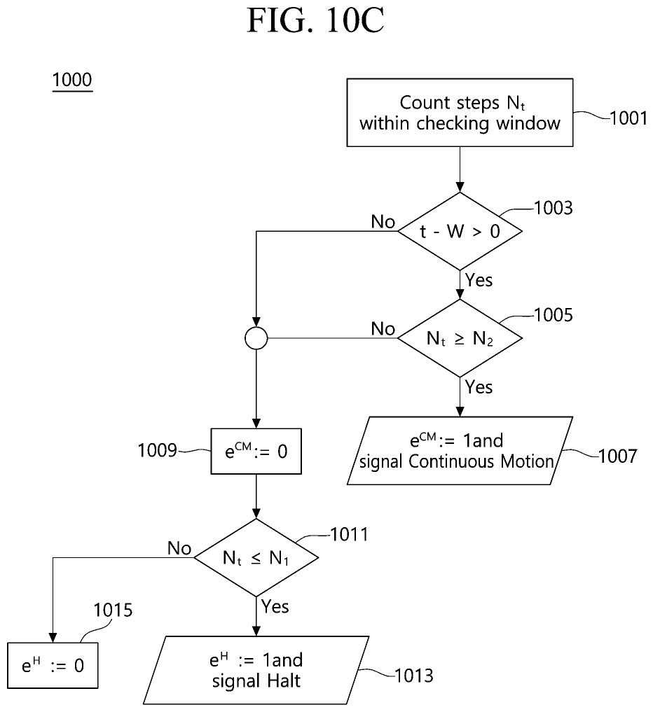

FIGS. 10A to 10C show an example process to detect motion events in accordance with an embodiment. In FIGS. 10A to 10C, the process operates on a sample-by-sample basis to detect a continuous motion (CM) event and a halt (H) event.

FIG. 10A illustrates a timing diagram depicting the detection of a continuous motion (CM) event in accordance with an embodiment. Referring to FIG. 10A, the timing diagram indicates that the user walks steadily for approximately 20 seconds starting around at t=10 s. In FIG. 10A, the MSD 730 detects 9 peaks (N=9) within the checking window (W=5 s), where N₂ is set to be smaller than or equal to 9. Subsequently, the MSD 730 sets the corresponding bit e^{CM} and signals the CM event to the PSM 740 around at t=16 s.

FIG. 10B illustrates a timing diagram depicting the detection of a halt (H) event in accordance with an embodiment. Referring to FIG. 10B, the timing diagram indicates that the user slows down and reaches a complete halt around t=12 s. The MSD 730 detects only 3 peaks (N=3) within the checking window (W=5 s), where N₁ is set to be larger than or equal to 3. Then, the MSD 730 sets the corresponding bit e^{H} and signals the halt (H) event to the PSM 740.

FIG. 10C illustrates an example flowchart depicting a process performed by the MSD 730 to detect a continuous motion (CM) event or a halt (H) event in accordance with an embodiment. The flowchart depicted in FIG. 10C is based on examples of FIGS. 10A and 10B. Although one or more operations are described or shown in particular sequential order, in other embodiments the operations may be rearranged in a different order, which may include performance of multiple operations in at least partially overlapping time periods.

The process 1000 may begin in operation 1101. In operation 1001, the MSD 730 counts step Nₜ within the checking window (W).

In operation 1003, the MSD 730 determines if the observing time t is larger than the checking window W. If the observing time t is larger than the checking window W, the process 1000 proceeds to operation 1005.

In operation 1005, the MSD 730 determines whether the counted step Nₜ is equal to or larger than a threshold N₂. If the counted step Nₜ is equal to or larger than a threshold N₂, the process 1000 proceeds to operation 1007.

In operation 1007, the MSD 730 set the corresponding bit e^{CM}=1 and signals the continuous motion (CM) event to the PSM 740.

If the observing time t is equal to or smaller than the checking window W in operation 1003, or if the counted step Nₜ is smaller than the threshold N₂ in the operation 1005, the process 1000 proceeds to operation 1009.

In operation 1009, the MSD 730 set the corresponding bit e^{CM}=0. Then, the process 1000 proceeds to operation 1011.

In operation 1011, the MSD 730 determines whether the counted step Nₜ is equal to or larger than a threshold N₁. If the counted step Nₜ is equal to or larger than the threshold N₁, the process 1000 proceeds to operation 1013. Otherwise, the process 1000 proceeds to operation 1005.

In operation 1013, the MSD 730 set the corresponding bit e^{H}=1 and signals the halt (H) event to the PSM 740.

In operation 1015, the MSD 730 set the corresponding bit e^{H}=0.

### Bounded Motion and Waver

The MSD 730 detects a bounded motion (BM) event when a dispersion Δϕₜ of the orientation angles contained in the checking window is less than a threshold 81, where the checking window ends in the most recent orientation reading ϕₜ and contains all acceleration values {ϕ_{τ}}, such that t−W≤τ≤t. In this disclosure, the dispersion measures the variation of a sequence of numbers, such as orientation angles. In an embodiment, the simple moving circular mean absolute deviation (SM-CMAD) is used to measure dispersion, as introduced as follows:

$$CMAD = arctan ( \frac{{\sum }_{n} sin \vert {ϕ}_{n} - \overline{ϕ} \vert}{{\sum }_{n} cos \vert {ϕ}_{n} - \overline{ϕ} \vert} )$$

where {ϕₙ} is a set of angles, and ϕ̅ is the circular average defined as:

$$\overline{ϕ} = arctan ( \frac{{\sum }_{n} sin {ϕ}_{n}}{{\sum }_{n} cos {ϕ}_{n}} )$$

In some embodiments, the range of the unwrapped sequence of orientation readings can be used. Unwrapping addresses situations where |ϕₙ-ϕₙ₋₁|≥180°. In such cases, unwrapping an angle refers to repetitively adding −360° or 360° to ϕₙ until the jump is less than 180°. Accordingly, the MSD 730 can unwrap the orientation sequence {a_{τ}} within the checking window [t−W,t], determine the maximum and minimum angles ϕₘₐₓ and ϕₘᵢₙ, and compute the dispersion Δϕ as the range of the difference ϕₘₐₓ−ϕₘᵢₙ.

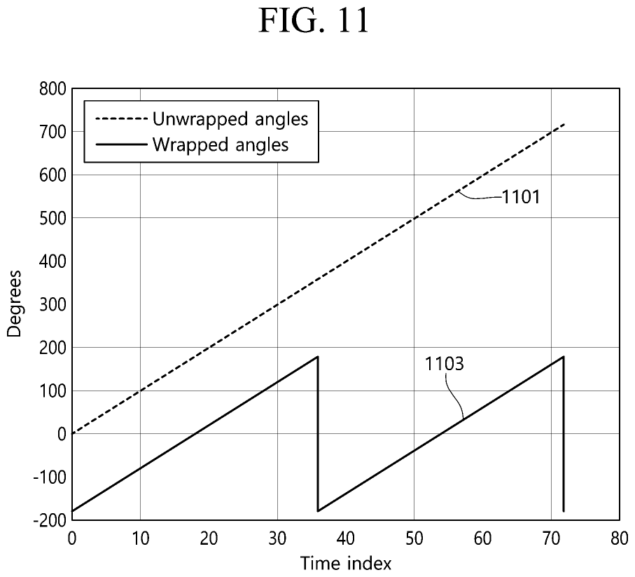

FIG. 11 shows an example comparing unwrapped angles and wrapped angles in accordance with an embodiment. Referring to FIG. 11, unwrapped angles 1101 linearly increase over time, while wrapped angles 1103 wrap back to −180° whenever the degrees reach 180°.

When the MSD 730 detects a bounded motion (BM) event, it sets its corresponding bit e^{BM} and signals the bounded motion (BM) event to the PSM 740. Otherwise, the MSD 730 clears e^{BM}.

The MSD 730 detects a waver (W) event when the dispersion Δϕₜ of the orientation angles included in the checking window is greater than a threshold δ₁. For example, when the maximum dispersion δ₂ of the orientation angles within the checking window is greater than the threshold δ₁ (i.e., δ₂≥δ₁), the MSD 730 detect a waver (W) event. When the MSD 730 detects a waver (W) event, it sets its corresponding bit e^{W} and signals the waver (W) event to the PSM 740. Otherwise, the MSD 730 clears e^{W}.

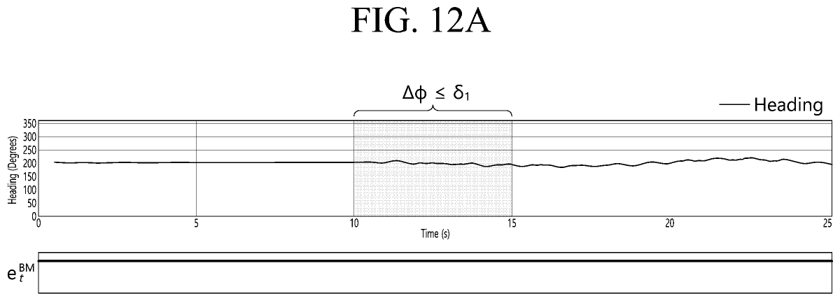

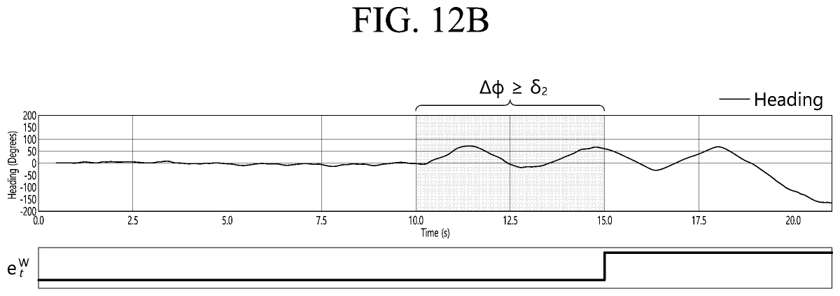

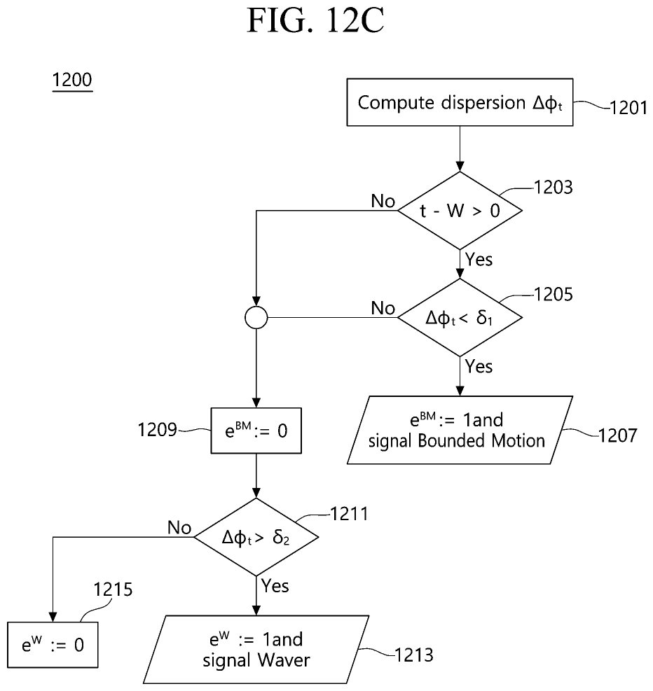

FIGS. 12A to 12C show another example process to detect motion events in accordance with an embodiment. In FIGS. 12A to 12C, the process 1200 operates on a sample-by-sample basis to detect a bounded motion (BM) event and a waver (W) event.

FIG. 12A illustrates a timing diagram depicting the detection of a bounded motion (BM) event in accordance with an embodiment. Referring to FIG. 12A, the timing diagram indicates that the user maintains a steady direction while moving. In FIG. 12A, the MSD 730 detects a very small dispersion within the checking window (Δϕₜ≤δ₁). For example, the MSD 730 detects an almost absent variation in the orientation. Subsequently, the MSD 730 sets the corresponding bit e^{BM} and signals the bounded motion (BM) event to the PSM 740.

FIG. 12B illustrates a timing diagram depicting the detection of a waver (W) event in accordance with an embodiment. Referring to FIG. 12B, the timing diagram indicates that the user turns around a lot during a short period of time. The MSD 730 detects a substantial dispersion within the checking window (Δϕₜ≥δ₂). Then, the MSD 730 sets the corresponding bit e^{W} and signals the waver (W) event to the PSM 740.

FIG. 12C illustrates an example flowchart depicting a process performed by the MSD 730 to detect a bounded motion (BM) event or a waver (W) event in accordance with an embodiment. The flowchart depicted in FIG. 12C is based on examples of FIGS. 12A and 12B. Although one or more operations are described or shown in particular sequential order, in other embodiments the operations may be rearranged in a different order, which may include performance of multiple operations in at least partially overlapping time periods.

The process 1200 may begin in operation 1201. In operation 1201, the MSD 730 computes dispersion Δϕₜ.

In operation 1203, the MSD 730 determines if the observing time t is larger than the checking window W. If the observing time t is larger than the checking window W, the process 1200 proceeds to operation 1205.

In operation 1205, the MSD 730 determines whether the dispersion Δϕₜ is smaller than a threshold δ₁. If the dispersion Δϕₜ is smaller than the threshold δ₁, the process 1200 proceeds to operation 1207.

In operation 1207, the MSD 730 set the corresponding bit e^{BM}=1 and signals the bounded motion (BM) event to the PSM 740.

If the observing time t is equal to or smaller than the checking window W in operation 1203, or if the dispersion Δϕₜ is equal to or larger than the threshold (δ₁) in the operation 1205, the process 1200 proceeds to operation 1209.

In operation 1209. the MSD 730 set the corresponding bit e^{BM}=0. Then, the process 1200 proceeds to operation 1211.

In operation 1211, the MSD 730 determines whether the dispersion Δϕₜ is larger than a threshold (δ₂). If the dispersion Δϕₜ is larger than the threshold (δ₂), the process 1200 proceeds to operation 1213. Otherwise, the process 1200 proceeds to operation 1205.

In operation 1213, the MSD 730 set the corresponding bit e^{W}=1 and signals the waver (W) event to the PSM 740.

In operation 1215, the MSD 730 set the corresponding bit e^{W}=0.

### Straight-Line Motion and Swerve

The MSD 730 detects a swerve(S) event when the step heading changes abruptly between the two most recent consecutive steps. For example, the MSD 730 detects a swerve(S) event when the difference of the step heading (Δθₗ=θₗ−θₗ₋₁) is a threshold δ₃ (i.e., Δθₗ=θₗ−θₗ₋₁≥δ₃). In some embodiments, the threshold δ₃ is larger than the value of thresholds discussed above (δ₃>δ₂≥δ₁).

The MSD 730 timestamps a swerve(S) event. The variable t^{S} denotes the time of the most recent swerve event. If the MSD 730 detects a swerve(S) event, it sets its corresponding bit e^{S} and signals the swerve(S) event to the PSM 740. Otherwise, the MSD 730 clears e^{S}.

The MSD 730 may detect a straight-line motion (STLM) event, for example, when all three of the following conditions are satisfied: i) a continuous motion bit e^{CM} is set, ii) a bounded motion bit e^{BM} is set, and iii) device has recovered from swerve for a predefined duration, for example, if t−t^{S}>W, where W is the duration of the checking window.

If the MSD 730 detects an STLM event, it sets its corresponding bit e^{STLM} and signals the STLM event to the PSM 740. Otherwise, the MSD 730 clears e^{STLM}.

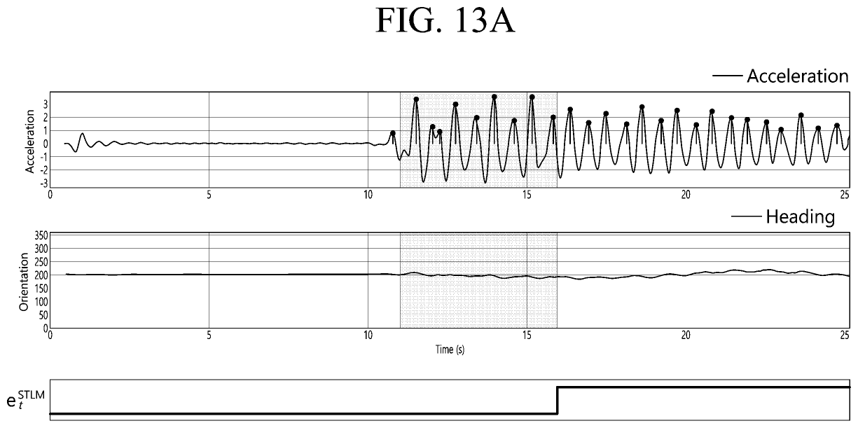

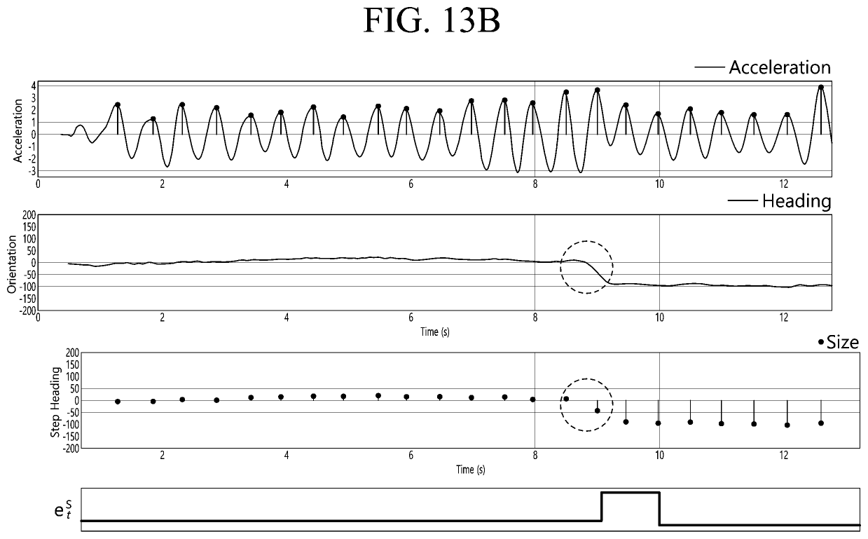

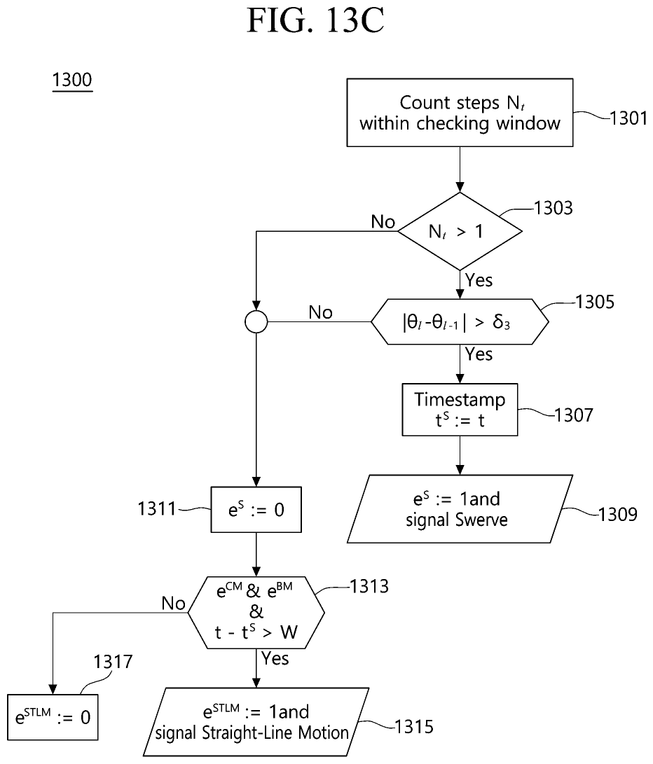

FIGS. 13A to 13C show another example process to detect motion events in accordance with an embodiment. In FIGS. 13A to 13C, the process operates on a sample-by-sample basis to detect a straight-line motion (STLM) event and a swerve(S) event.

FIG. 13A illustrates timing diagrams depicting the detection of a STLM event in accordance with an embodiment. Referring to FIG. 13A, the timing diagrams indicate that the user remains at rest until t=10 s because there are no changes in the acceleration and orientation. Then, the user starts walking continuously without taking breaks between steps over the checking window while maintaining a steady heading. The MSD 730 detects an STLM event, it sets its corresponding bit e^{STLM} and signals the STLM event to the PSM 740 around t=16 s.

FIG. 13B illustrates timing diagrams depicting the detection of a swerve(S) event in accordance with an embodiment. Referring to FIG. 13B, the timing diagrams indicate that the user heads, for example, eastbound until around t=8.5 s. The top second and third timing diagrams show significant changes in orientation and step heading around t=8.5 s, as the user makes a left turn and starts heading northbound. Subsequently, the user maintains a continuous motion while walking. The MSD 730 detects a swerve(S) event, and then it sets its corresponding bit e^{S} and signals the swerve(S) event to the PSM 740 around t=9 s. Subsequently, the MSD 730 recovers from the swerve(S) event around t=10 s if it does not detect abrupt changes in orientation and step heading.

FIG. 13C illustrates an example flowchart depicting a process performed by the MSD 730 to detect a straight-line motion (STLM) event and a swerve(S) event in accordance with an embodiment. The flowchart depicted in FIG. 13C is based on examples of FIGS. 13A and 13B. Although one or more operations are described or shown in particular sequential order, in other embodiments the operations may be rearranged in a different order, which may include performance of multiple operations in at least partially overlapping time periods.

The process 1300 may begin in operation 1301. In operation 1301, the MSD 730 counts step Nₜ within the checking window (W).

In operation 1303, the MSD 730 determines whether at least two consecutive steps are detected. If at least two consecutive steps are detected (Nₜ>1), the process 1300 proceeds to operation 1305.

In operation 1305, the MSD 730 determines whether the step heading changes abruptly between the two most recent consecutive steps. In some embodiments, it may be implemented by the equation: Δθₗ=θₗ−θₗ₋₁≥δ₃, where δ₃>δ₂≥δ₁. If the step heading changes abruptly between the most recent consecutive steps, the process 1300 proceeds to operation 1307.

In operation 1307, the MSD 730 timestamps a swerve event (t^{S}=t). Then, the process 1300 proceeds to operation 1309.

In operation 1309, the MSD 730 set the corresponding bit e^{S}=1 and signals the swerve(S) event to the PSM 740.

If two consecutive steps are not detected (Nₜ≤1) or if the step heading does not change abruptly between the most recent consecutive steps (Δθ₁=θₗ-θₗ₋₁<δ₃), the process 1300 proceeds to operation 1311.

In operation 1311. the MSD 730 set the corresponding bit e^{S}=0. Then, the process 1300 proceeds to operation 1313.

In operation 1313, the MSD 730 determines whether the following conditions are satisfied: i) a continuous motion bit e^{CM} is set, ii) a bounded motion bit e^{BM} is set, and iii) device has recovered from swerve for a predefined duration, for example, if t−t^{S}>W, where W is the duration of the checking window. If all conditions are satisfied, the process 1300 proceeds to operation 1315. Otherwise, the process 1300 proceeds to operation 1317.

In operation 1315, the MSD 730 sets its corresponding bit e^{STLM}=1 and signals the STLM event to the PSM 740.

In operation 1317, the MSD 730 clears e^{STLM} (e^{STLM}=0).

### Positioning State Machine (PSM)

The PSM 740 uses the motion event signals provided by the MSD 730 to switch among a plurality of positioning modes supported by the positioning engine 750.

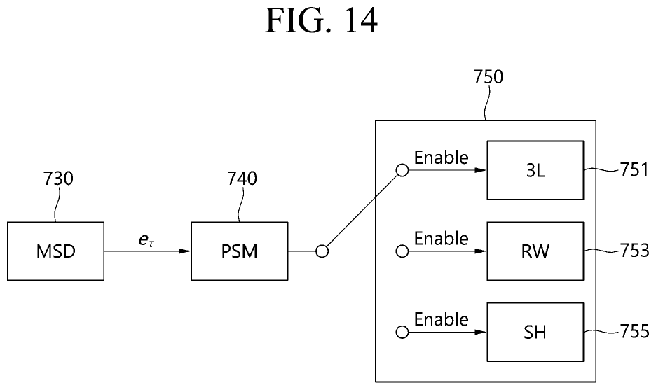

FIG. 14 shows an example model depicting switching positioning modes in accordance with an embodiment. Referring to FIG. 14, the positioning engine 750 includes, for example, three positioning modes: a trilateration (3 L) mode 751, a random walk (RW) mode 753, and a step & heading (SH) mode 755.

The trilateration (3 L) mode 751 may estimate the position for the user or device using the trilateration algorithm, which is common in satellite navigation, based on RTT distance measurements obtained from the ranging device 720. In some embodiments, other wireless-signal-related measurements and statistics (e.g., RSSI) can also be used. The trilateration (3 L) estimates the position of the user or device and minimizes the sum of square errors in distance from each of the anchor points.

The Random Walk (RW) mode 753 may estimate the position of the user or device based on RTT distance measurement obtained from the ranging device 720. In some embodiments, other wireless-signal-related measurements and statistics can also be used.

The Step & Heading (SH) mode 755 may estimate the position of the user or device based on a combination of RTT distance measurements obtained from the ranging device 720, and step size and heading information obtained the sensing device 710.

The PSM 740 switches the positioning mode among the three positioning modes supported by the positioning engine 750, based on the motion signal vector et provided from the MSD 730.

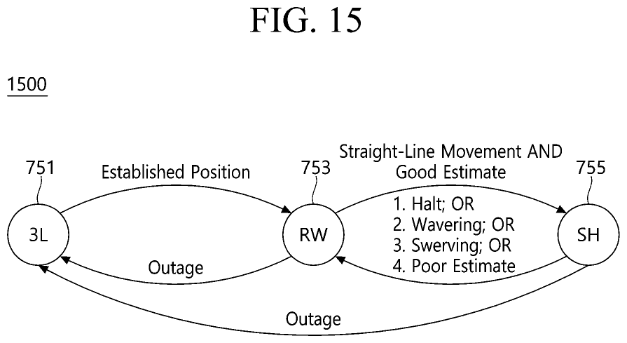

FIG. 15 shows a state diagram 1500 for one implementation of a position state machine in accordance with an embodiment.

Referring to FIG. 15, modes/states of the positioning state machine (PSM) 750 are illustrated for a configuration. The PSM 740 starts in the 3 L mode 751 and remains in or switches to another state based on the following conditions.

If there are enough measurements from enough anchor points to obtain position estimate of the user/device (e.g., more than 3 measurements), the PSM 740 switches or changes from the 3 L mode 751 to the RW mode 753. If there are not enough measurements (e.g., equal to or smaller than 3 measurements), the PSM 740 remains in the 3 L mode 751 and continues to estimate the position for the user or device using the trilateration algorithm.

In the RW mode 753, if two conditions are satisfied: i) detection of STLM event and ii) good estimate quality, the PSM 740 switches or changes from the RW mode 753 to the SH mode 755. In some embodiments, the STLM events may require a continuous motion and a bounded motion event. Further, the good estimate quality indicates the reliability of the estimate. For example, it can be determined as good estimate quality when estimate mean square error (MSE) is less than a predetermined cap or threshold. If both conditions are not satisfied, the PSM 730 remains in the RW mode 753. Additionally, if there are insufficient measurements or no measurements (i.e., outage), the PSM 740 switches or changes back to the 3 L mode 751.

In the SH mode 755, if any of following conditions is satisfied: detection of i) a halt (H) event, ii) a waver (W) event, or iii) a swerve(S) event, or iv) poor estimate quality, the PSM 740 switches or changes back to the RW mode 753. Additionally, if there are insufficient measurements or no measurements (i.e., outage), the PSM 740 switches or changes back to the 3 L mode 751.

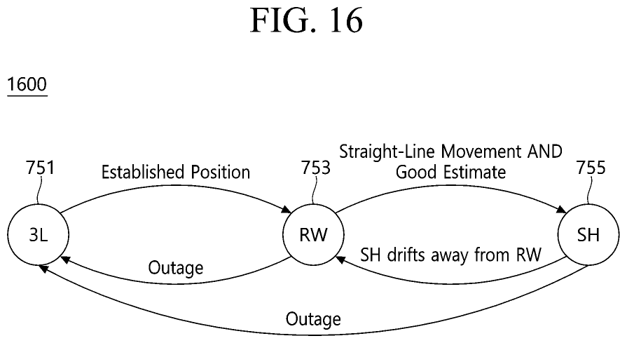

FIG. 16 shows a state diagram 1600 for one implementation of a position state machine in accordance with an embodiment. Various operations and conditions of the state diagram 1600 are the same as or similar to corresponding operations and conditions of the state diagram 1500 depicted in FIG. 15. Compared to the state diagram 1500, in the SH mode 755, the PSM 740 switches or changes back to the RW mode 753 if the estimate provided by the SH mode 755 significantly drifts from the estimate provided by the RW mode 753.

In this state machine 1600, the positioning engine 750 may run the operations under the RW mode 753 all the time even when the mode is set to the SH mode 755. In an embodiment, if the SH mode 755 is set, the positioning engine 750 generates two sets of position estimates: i) a first sequence {\hat{x}^{RW}} generated by the RW mode 753 and ii) a second sequence {\hat{x}^{SH}} generated by the SH mode 755. For each pair of position estimates \hat{x}ₖ^{RW} and \hat{x}ₖ^{SH} discrete time step k, the PSM 740 computes the distance between them, and averages it over time, for example, by employing either a weighted or non-weighted average. If the average distance exceeds a threshold, the PSM 740 switches back to the RW mode 753.

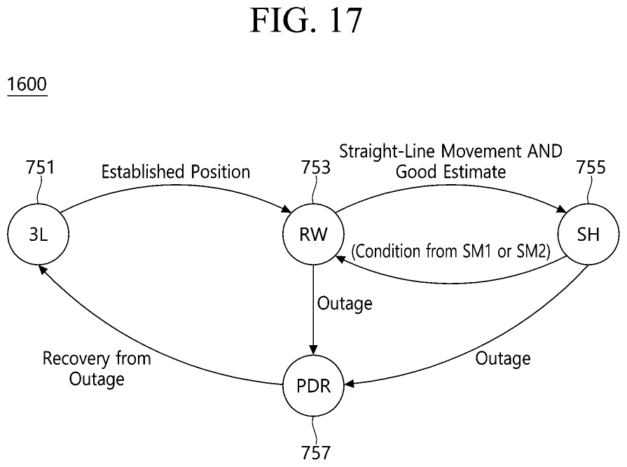

FIG. 17 shows a state diagram 1700 for one implementation of a position state machine in accordance with an embodiment. Various operations and conditions of the state diagram 1700 are the same as or similar to corresponding operations and conditions of the state diagram 1500 or the state diagram 1600.

In the example of FIG. 17, the state diagram 1700 includes the PDR mode 757 in addition to the modes illustrated in the state diagrams 1600 and 1700. In the PDR mode 757 of this example, the positioning algorithm uses only the step size and the heading information, except using RTT measurements. The PSM 740 may switch to the PDR mode 757 instead of the 3 L mode 751 when there are insufficient measurements or no measurements (i.e., outage).

Referring to FIG. 17, in the SH mode 755, the PSM 740 switches or changes back to the RW mode 753 on the conditions described in the state diagram 1600 or 1700. Furthermore, other conditions may be applied in various other embodiments.

In the RW mode 753, the PSM 740 switches or changes to the PDR mode 757 if there are insufficient measurements or no measurements (i.e., outage). Similarly, in the SH mode 755, the PSM 740 transitions to the PDR mode 757 if there are insufficient measurements or no measurements (i.e., outage). In the PDR mode 757, the PSM 740 switches or changes to the 3 L mode 751 upon a recovery from the outage. For example, the PSM 740 transitions to the 3 L mode 751 if there are now sufficient measurements available or at least certain number of measurements.

The embodiments outlined in this disclosure can be utilized in conjunction with positioning algorithms that use the step size and heading information as inputs. Various embodiments provided in this disclosure can be employed in diverse environments, including museums for navigating through sections of museum and reading about pieces of art in the user's vicinity, transportation terminals such as subway, train stations, and airports for navigating to gates and shops, stores for locating products, and homes for triggering smart home actions, such as turning on lights when the user enters a room.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for estimating a position of an object, the method comprising:
receiving a motion event signal indicating a motion type of the object, the motion type being determined based on sensing data provided by one or more sensors;
receiving one or more ranging measurements for distances between the object and one or more anchor points from a ranging device;
determining a mode among a plurality of positioning modes based on the motion event and the one or more ranging measurements; and
estimating a position of the object using the determined mode.

2. The method of claim 1, wherein the sensing data are associated with at least one of acceleration, orientation, rotational velocity, step size or step heading.

3. The method of claim 1, wherein the plurality of positioning modes includes a first positioning mode and a second positioning mode, wherein:
the first positioning mode estimates a position of the object based on a combination of the ranging measurements for the distances and the sensor data associated with step size and step heading; and
the second positioning mode estimates a position of the object based on round trip time (RTT) based distance measurement.

4. The method of claim 3, wherein the determining the mode comprises:
switching from the second positioning mode to the first positioning mode when a motion event signal indicating that the object moves in a straight line is received.

5. The method of claim 3, wherein the determining the mode comprises:
switching from the first positioning mode to the second positioning mode when a motion event signal indicating stop, fluctuation, or change in a heading of the object is received.

6. The method of claim 3, wherein the determining the mode comprises:
switching from the first positioning mode to the second positioning mode when a difference between a position estimate based on the first positioning mode and a position estimate based on the second positioning mode is larger than a threshold.

7. The method of claim 3, wherein the plurality of positioning modes further includes a third positioning mode that estimates a position of the object using a trilateration algorithm.

8. The method of claim 7, wherein the determining the mode comprises:
switching from the first positioning mode or the second positioning mode to the third positioning mode when a number of ranging measurements for the distances is smaller than a predetermined number.

9. The method of claim 7, wherein the plurality of positioning modes further includes a fourth positioning mode that estimates a position of the object using a positioning algorithm based on step size and step heading.

10. The method of claim 9, wherein the determining the mode comprises:
switching from the first positioning mode or the second positioning mode to the fourth positioning mode when a number of ranging measurements for the distances is smaller than a predetermined number.

11. A device for estimating a position of the device, comprising:
one or more sensors configured to provide sensing data; and
a processor coupled to the one or more sensors, the processor configured to cause:
receiving a motion event signal indicating a motion type of the device, the motion type being determined based on sensing data provided by the one or more sensors;
measuring distances between the device and one or more anchor points;
determining a mode among a plurality of positioning modes based on the motion event signal and one or more measurements of the distances; and
estimating a position of the device using the determined mode.

12. The device of claim 11, wherein the sensing data are associated with at least one of acceleration, orientation, rotational velocity, step size or step heading.

13. The device of claim 11, wherein the plurality of positioning modes includes a first positioning mode and a second positioning mode, wherein:
the first positioning mode estimates a position of the device based on a combination of the one or more measurements for the distances and the sensor data associated with step size and step heading; and
the second positioning mode estimates a position of the device based on round trip time (RTT) based distance measurement.

14. The device of claim 13, wherein the determining the mode comprises:
switching from the second positioning mode to the first positioning mode when a motion event signal indicating that the device moves in a straight line is received.

15. The device of claim 13, wherein the determining the mode comprises:
switching from the first positioning mode to the second positioning mode when a motion event signal indicating stop, fluctuation, or change in a heading of the object is received.

16. The device of claim 13, wherein the determining the mode comprises:
switching from the first positioning mode to the second positioning mode when a difference between a position estimate based on the first positioning mode and a position estimate based on the second positioning mode is larger than a threshold.

17. The device of claim 13, wherein the plurality of positioning modes further includes a third positioning mode that estimates a position of the device using a trilateration algorithm.

18. The device of claim 17, wherein the determining the mode comprises:
switching from the first positioning mode or the second positioning mode to the third positioning mode when a number of measurements for the distances is smaller than a predetermined number.

19. The device of claim 17, wherein the plurality of positioning modes further includes a fourth positioning mode that estimates a position of the device using a positioning algorithm based on step size and step heading.

20. The device of claim 19, wherein the determining the mode comprises:
switching from the first positioning mode or the second positioning mode to the fourth positioning mode when a number of ranging measurements for the distances is smaller than a predetermined number.
